(19) United States
(12) Patent Application Publication
(10) Pub. No.: US 2021/0263303 A1
(43) Pub. Date: Aug. 26, 2021

(54) OPTICAL SCANNING DEVICE WITH BEAM COMPRESSION AND EXPANSION

(71) Applicant: SZ DJI TECHNOLOGY CO., LTD., Shenzhen City (CN)

(72) Inventors: Shuai DONG, Shenzhen City (CN); Xiaoping Hong, Shenzhen City (CN); Xiang Liu, Shenzhen City (CN); Huai Huang, Shenzhen City (CN); Jin Zhao, Shenzhen City (CN)

(73) Assignee: SZ DJI Technology Co., Ltd.

(21) Appl. No.: 17/215,654

(22) Filed: Mar. 29, 2021

Related U.S. Application Data
(63) Continuation of application No. PCT/CN2019/071769, filed on Jan. 15, 2019.

(30) Foreign Application Priority Data
Sep. 30, 2018 (CN) PCT/CN2018/109186

(51) Int. Cl. G02B 26/10; G02B 26/08; G02B 26/12; G02B 27/09

(52) U.S. Cl. CPC G02B 26/101; G02B 26/0883; G02B 27/0972; G02B 26/12; G02B 26/0816

(57) ABSTRACT

Disclosed are techniques for scanning an optical beam in two dimensions (e.g. azimuth and elevation) and for increasing or decreasing a field-of-view (FOV) of the scanned beam. Scanning may be performed by various configurations of prisms, rotatable mirrors, and/or rotatable polygonal mirrors. In some configuration, changes to the FOV of the scanned beam may be performed by prisms positioned with a predetermined angular relationship and may include other optical components, as well. Depending on the predetermined angular relationship, the prisms can expand the FOV along one or more axis and/or may compress the FOV along one or more axis.

### TECHNICAL FIELD

The present technology is generally directed to optical scanning devices and methods, an in particular, to generation and manipulation of scanning optical patterns.

### BACKGROUND

Optical scanners have many applications including application to autonomous driving. The environment of a mobile platform can typically be scanned or otherwise detected using one or more sensors such as LiDAR sensors which typically transmit a pulsed signal (e.g. laser signal) and detect reflections of the pulsed signal. Three-dimensional information about the environment can be determined in this way (e.g., at laser scanning points). Various sources of interference (e.g., changing ground level, types of obstacles, or the like) and limitations of location and position technologies (e.g., the precision of GPS signals) can affect obstacle avoidance and navigation applications. Accordingly, there remains a need for improved optical scanning and processing techniques to improve the accuracy and reliability of three-dimensional information obtained from optical scanners.

### SUMMARY

The following summary is provided for the convenience of the reader and identifies several representative embodiments of the disclosed technology.

In one aspect an optical scanning device is disclosed. The optical scanning device includes a beam scanner coupled to an input light source to receive an input light beam and operable to generate a scanning optical beam having a first scanning pattern. The optical scanning device further includes a first optical element positioned to receive the scanning optical beam and cause at least a change in a dimension of the scanning optical beam, and a second optical element positioned to receive light that is output from the first optical element and to cause another change in one or both of a direction or the dimension of the scanning optical beam to produce a second scanning pattern at an image plane with either an expanded or a compressed field of view.

In another aspect, an optical expansion or compression device is disclosed that includes at least two optical elements including a first optical element to receive an optical beam having a first scanning pattern and produce a first redirected beam, and a second optical element to receive the first redirected beam and produce a second redirected beam, wherein the second redirected beam has a second scanning pattern. Each of the first and the second optical elements are configured to be positioned with respect to each other at a range of angles such that when the first optical element is positioned with respect to the second optical element in a first predetermined range of angles, the second scanning pattern is produced with an expanded a field of view, and when the first optical element is positioned with respect to the second optical element in a second predetermined range of angles, the second scanning pattern is produced with a compressed field of view.

In another aspect, an optical scanning device is disclosed that includes a first beam scanner section configured to receive an input light beam and to produce a first scanning pattern including a circular or an oval scanning beam section, and a second beam scanner section positioned to receive light from the first beam scanner section and to produce an output beam having a second scanning pattern, wherein the second the second scanning pattern includes at least one flat or straight boundary.

In another aspect, an optical scanning device is disclosed that includes a first beam scanner section including a first prism and a second prism, the first and the second prisms configured to rotate in opposite directions with respect to each other, the first prism having a first rotation speed and the second prism having a second rotation speed, and a second beam scanner section positioned to receive light from the first beam scanner section, the second beam scanning section including a third and a fourth prism, wherein the third and the fourth prisms are configured to rotate in opposite directions with respect to each other, the third prism having a third rotation speed and the fourth prism having a fourth rotation speed, wherein the first, the second, the third and the fourth rotation speeds are selectable to produce an output beam having a particular scanning pattern.

The following features can be included in various combinations. The first optical element is a first prism, the second optical element is a second prism, and the first prism is positioned with respect to the second prism at an angle within a predetermined range of angles to produce the second scanning pattern with an expanded field of view compared to the field of view associated with the first scanning pattern. The first prism is positioned such that an angle formed between an optical axis of the optical scanning device and a first surface of the first prism that receives the scanning optical beam is greater than 90 degrees, and the second prism is positioned such that an angle formed between the optical axis of the optical scanning device and a second surface of the second prism that outputs the scanning optical beam is less than 90 degrees. The first optical element is a first prism, the second optical element is a second prism, and the first prism is positioned with respect to the second prism at an angle within a predetermined range of angles to produce the second scanning pattern with a compressed field of view compared to the field of view associated with the first scanning pattern. The first prism is positioned such that an angle formed between an optical axis of the optical scanning device and a first surface of the first prism that receives the scanning optical beam is less than 90 degrees, and the second prism is positioned such that an angle formed between the optical axis of the optical scanning device and a second surface of the second prism that outputs the scanning optical beam is greater than 90 degrees. A center of the produced second scanning pattern is shifted with respect to a center of the first scanning pattern. The first optical element and the second optical element are each configured to be positioned at an angle within a range of angles with respect to an optical axis of the optical scanning device, and wherein an amount of expansion or compression of the field of view associated with the second scanning pattern is increased or decreased based on the selection of the angle for one or both of the first and second optical elements. The first optical element and the second optical element are positioned to cause an asymmetry in the second scanning pattern in an elevation angle compared to an azimuth angle. The beam scanner includes a pair of prisms configured to rotate in opposite directions with respect to one another to produce the scanning optical beam having the first scanning pattern. The beam scanner includes one or more rotatable mirrors. At least one of the first or the second optical elements comprises a lens. The second scanning pattern is different in size from the first scanning pattern in at least one dimension. The second optical element is positioned to compensate for at least a portion of a lateral shift introduced by the first optical element. The first optical element is positioned to expand and laterally shift the scanning optical pattern, and the second optical element is positioned to (a) compensate for at least a portion of the lateral shift in the scanning optical pattern, and (b) to either further expand or to compress the scanning optical pattern. The first optical element is positioned to compress and laterally shift the scanning optical pattern, and the second optical element is positioned to (a) compensate for at least a portion of the lateral shift in the scanning optical pattern, and (b) to either further compress or to expand the scanning optical pattern. The second optical element includes an antireflection coating on a second surface thereof that outputs the scanning optical beam, the antireflection coating allowing the optical scanning beam to exit the second surface without a substantial loss while preventing light from entering the second element through the second surface. The first optical element is a first wedge prism, and the second optical element is a second wedge prism. One or both of the first wedge prism or the second wedge prism have a tapered cross section in two different directions. The first wedge prism, and the second wedge prism are oriented such that a plane passing through an apex of the first wedge prism is approximately at 90 degrees with respect to a plane passing through an apex of the second wedge prism.

### BRIEF DESCRIPTION OF THE DRAWINGS

FIG. 1 depicts an example of an optical apparatus including a beam scanner and prisms for expansion of a field of view.

FIG. 2A depicts an example of an optical apparatus including a beam scanner and prisms for compression of a field of view.

FIG. 2B depicts another example of an optical apparatus including a beam scanner and prisms for compression of a field of view that is shown in three dimensions.

FIG. 3A depicts another example of an optical apparatus including prisms to perform scanning and prisms for compression of a field of view.

FIG. 3B1 depicts an example of a ray tracing diagram for an optical apparatus including prisms to change a field of view.

FIG. 3B2 depicts a 3D view of the optical apparatus depicted in FIG. 3B1.

FIG. 3C is another illustration of two prisms used to change a field of view (FOV).

FIG. 3D illustrates a three-dimensional view of the prisms and their orientation with respect to one another.

FIG. 4 depicts an example of scan patterns produced by an optical apparatus in accordance with the disclosed embodiments.

FIG. 5 depicts an example of an optical apparatus including prisms to perform scanning and various optical components for field of view compression or expansion.

FIG. 6A depicts an example of a prism and a refracted beam.

FIG. 6B depicts an example plot of a derivative of a deflection angle of a prism with respect to an input angle showing various regions.

FIG. 6C depicts a 3D view of an example prism.

FIG. 6D depicts another 3D view of an example prism.

FIG. 6E depicts a schematic presentation of an example prism showing various dimensions and an angle.

FIG. 6F1 depicts a ray tracing diagram for a prism tilted with respect to incoming rays with the apex closer to the source than the base.

FIG. 6F2 depicts a 3D view of the prism depicted in FIG. 6F1.

FIG. 6G1 depicts a ray tracing diagram for a prism tilted with respect to incoming rays with the base closer to the source than the apex.

FIG. 6G2 depicts a 3D view of the prism depicted in FIG. 6G1.

FIG. 6H1 depicts a ray tracing diagram of prism tilted with respect to incoming rays with the base closer to the source than the apex with a greater angle of incidence with respect to incoming rays.

FIG. 6H2 depicts a 3D view of the prism depicted in FIG. 6H1.

FIG. 7 depicts an example of a planar mirror scanner and a rotatable polygonal mirror scanner.

FIG. 8 depicts examples of dual scanners and examples of corresponding scan patterns.

FIG. 9 depicts another example of a dual scanner and another example of a corresponding scan pattern.

FIG. 10 depicts other examples of dual scanners and other examples of corresponding scan patterns.

FIG. 11 depicts additional examples of dual scanners.

FIG. 12 depicts further examples of dual scanners.

FIG. 13 depicts examples of scan patterns and an example of four prisms.

### DETAILED DESCRIPTION

Some aspects of the disclosed technology relate to techniques for producing a scanning optical beam in two dimensions (e.g. azimuth and elevation) that, among other feature and benefits, enable a change in the size of the scanning optical beam, including an increase or decrease in a field-of-view (FOV) of the scanned beam. Scanning may be performed by various configurations of prisms, rotatable mirrors, and/or rotatable polygonal mirrors. Changes to the FOV of the scanned beam may be performed by prisms positioned with a predetermined angular relationship and may include other optical components, as well. Depending on the predetermined angular relationship, the prisms can expand the FOV along one or more axis and/or may compress the FOV along one or more axis.

Additional aspects of the disclosed technology relate to controlling the shape of an optical scanning beam to produce scanning beam patterns that include rectangular scanning patterns (as opposed to oval or circular patterns), or more generally, scanning patterns that include one or more flat or straight side. The disclosed scanners include at least two sections that allow control of the produced scanning patterns in different directions.

In one exemplary embodiment, an FOV expansion/compression (which may also be referred to herein as beam expansion/compression) technique is disclosed that uses stationary prisms. By selecting the prism wedge angle, the relative angles between the prisms, and the material selection based on at least the material refractive index, a prescribed FOV expansion and/or compression can be achieved.

Laser beam scanning is used in laser radar, laser guidance, optical communications, precision tracking system, and many other applications. Previously, solutions have included mechanical scanning (e.g., scanning galvanometer, rotating mirror, microelectromechanical system (MEMS) scanners. and so on), and scanning phased arrays (e.g. acousto-optical scanning, scanning via electro-optical crystal, liquid crystal phased arrays, phased array gratings). Mechanical scanning is the most mature scanning technology but has several disadvantages including low scanning speeds and the scanning devices require large volumes. Phased array scanning is controlled by modulating the phase of an array of light beams, thereby realizing directional deflection of the light beam with high precision, high speed, and no (or little) mechanical inertia but has disadvantages including limited scanning range (usually no more than ±10°), a complex control system, limited efficiency (high power consumption), and high cost.

In some applications such as automotive LIDAR, the FOV in an azimuth direction (looking right and left relative to the vehicle) should be broader than the FOV in an elevation direction (looking up and down) because objects of interest such as other cars, obstacles, etc. are more dense in azimuth than in elevation. In some example embodiments a laser spot size may be large in azimuth (e.g., has a large divergence angle in azimuth).

The disclosed beam scanning devices, in some embodiments, include a beam scanning portion and a FOV expansion/contraction portion. The beam scanning portion may include a galvanometer (driven mirror), a MEMS device, acoustic or electro-optical scanning phased array. The FOV expansion/compression portion can include prisms fixed in location that expand or compress a field of view in one or two dimensions. One or more angles between the prisms determines whether the FOV is expanded or compressed. For example, the orientation and angle at which the two prisms are placed relative to the incident light may determine whether the incident light is compressed or expanded. By expanding/contracting the FOV with the prisms, the complexity of the control system of the scanner can be reduced. In some embodiments, additionally or alternatively, other optical components, such as lines or gratings can be used to produce the expanded or compressed field of view.

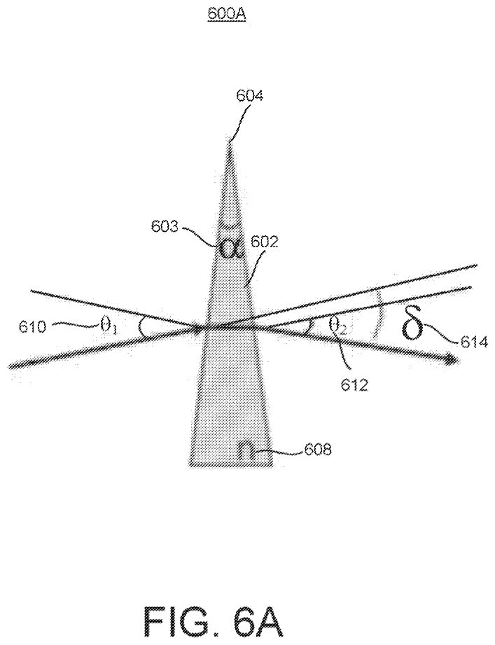

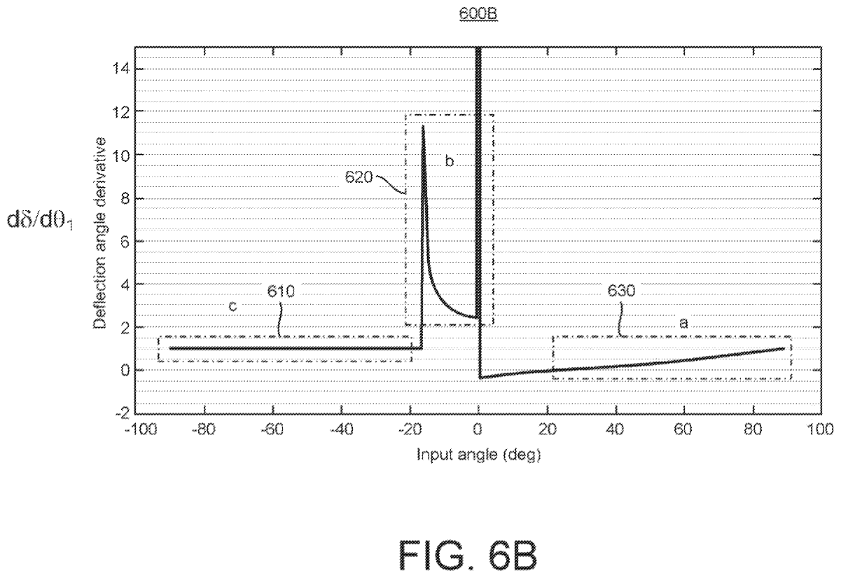

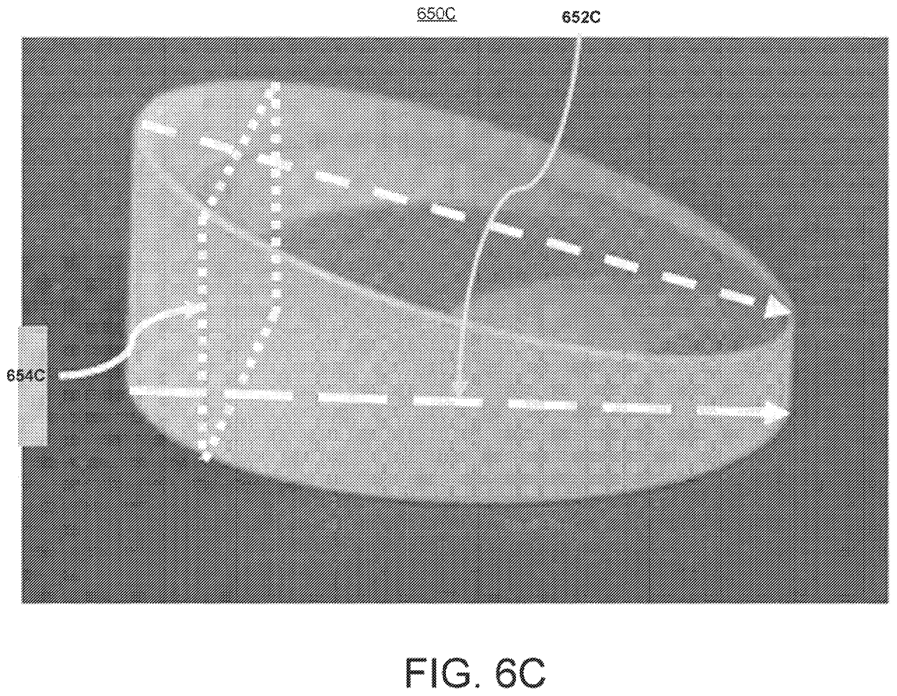

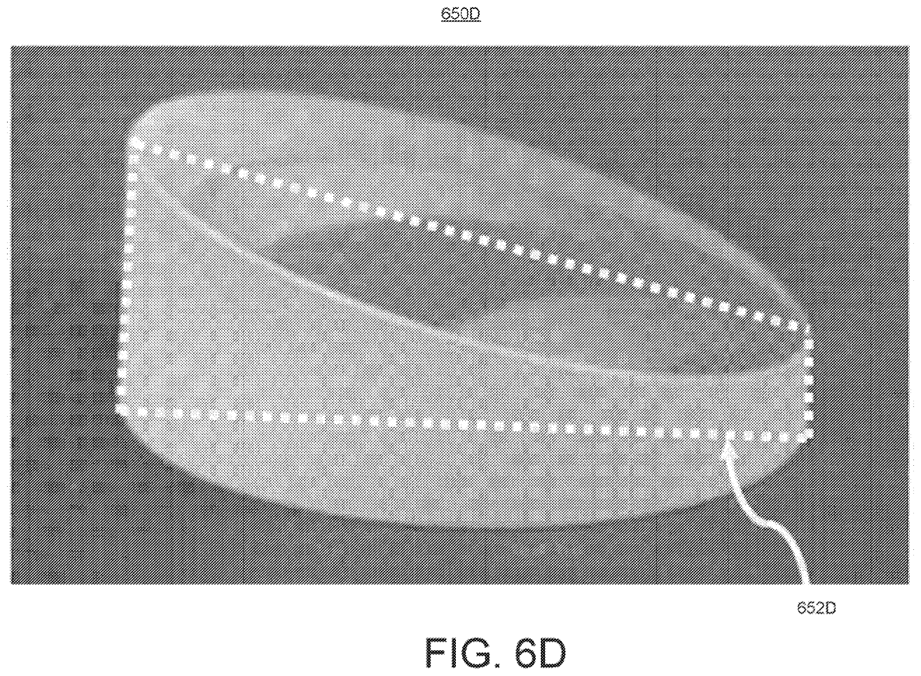

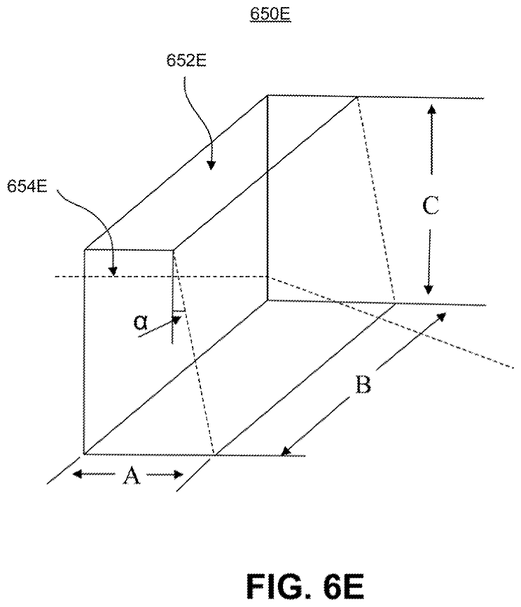

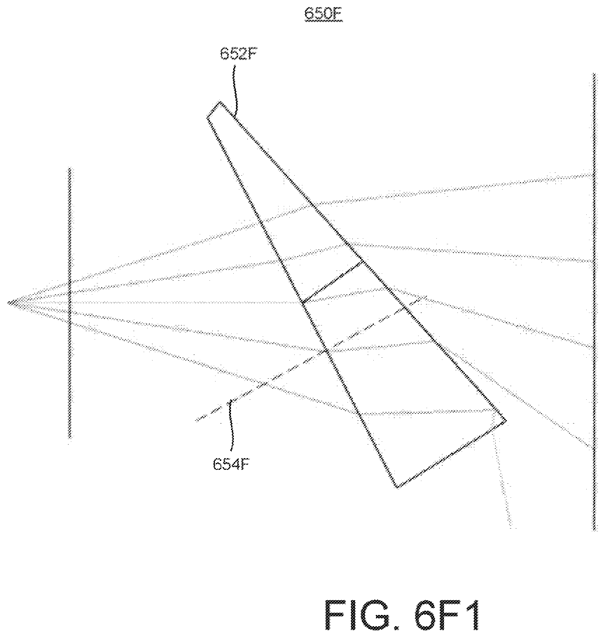

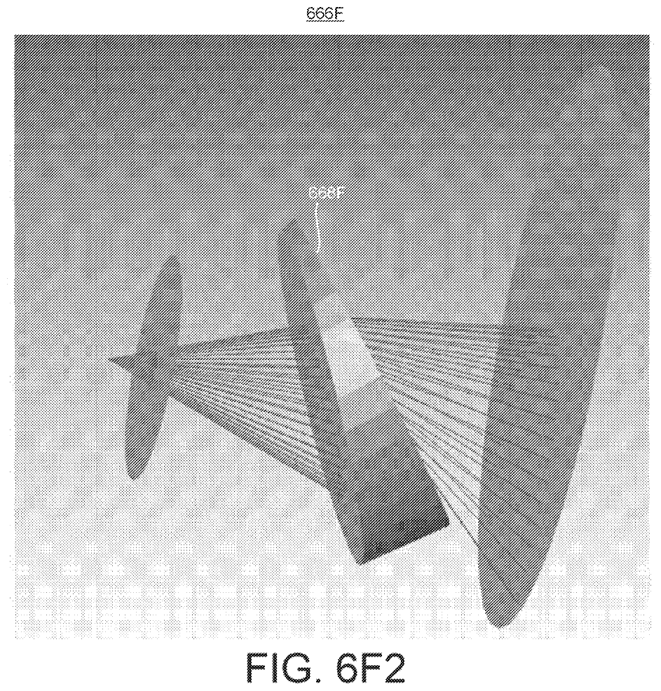

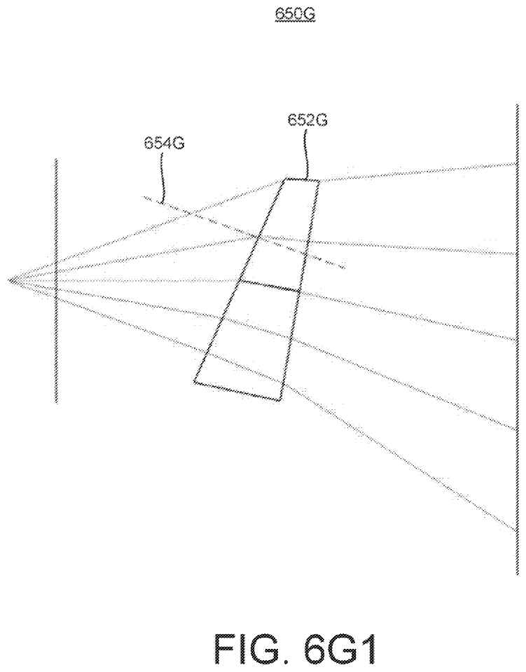

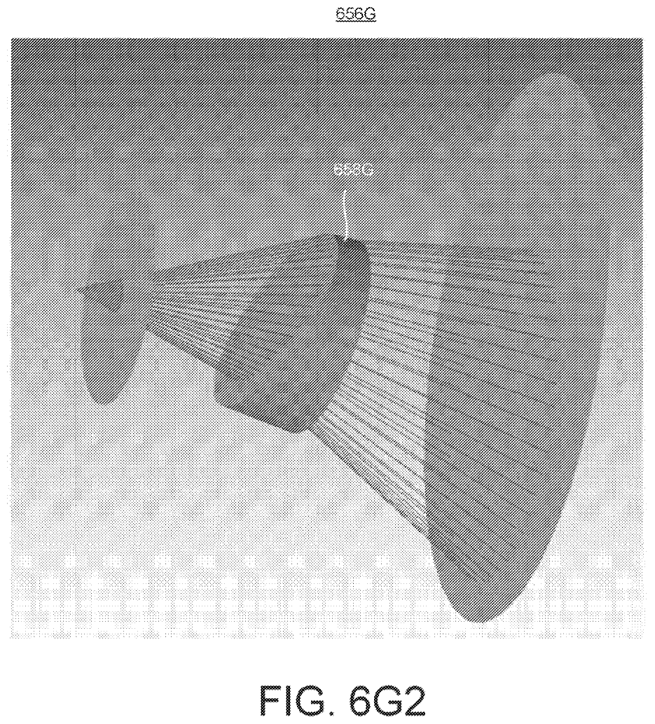

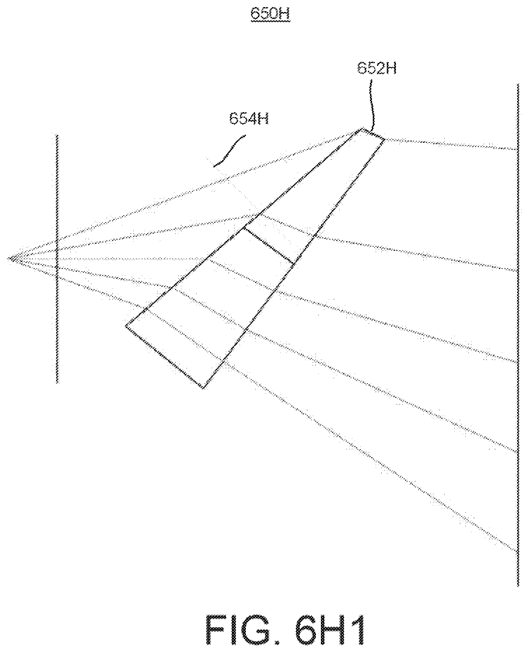

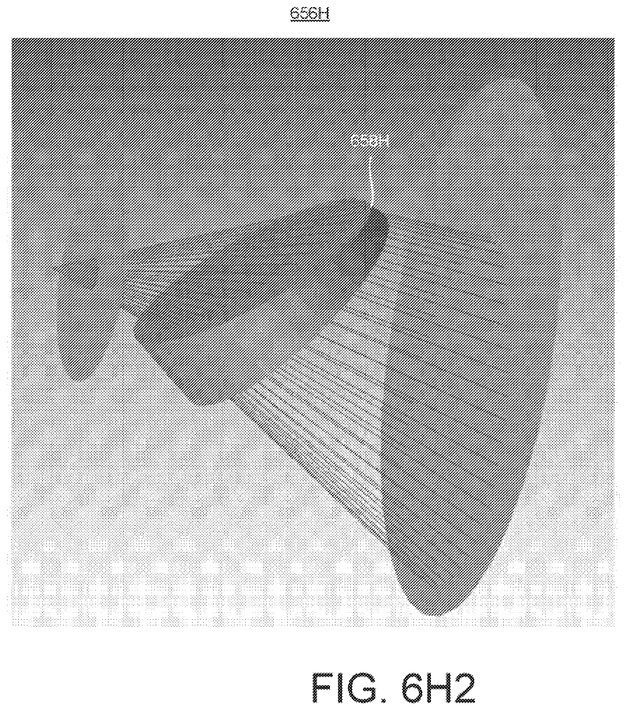

For illustrative purposes, FIGS. 6F1 and 6G1 below show examples of how the orientation and angle of a prism with respect to the light that is incident thereon can produce an expanded or compressed FOV. Two example cases include:

### Example 1

When a diverging beam is incident on the prism oriented as shown in FIG. 6F1, the beams that are incident on the top (e.g., narrower) section of the prism at the angled shown are refracted at a smaller angle compared to the beams that are incident on the bottom section of the prism. As a result, the beams that exit the prism, while may provide an overall expansion or compression of the FOV, the top/bottom sections of the light cone may be subject to differing compression/expansion factors. FIG. 6F1 also shows the bottom ray that has undergone total internal reflection (which may or may not need to be avoided depending the application

### Example 2

FIG. 6G1 shows a prism that is tilted in a direction opposite to than shown in FIG. 6F1. Similar assessments regarding expansion or compression of the FOV can be made with regard to this configuration. Using two or more prisms in cascade would allow further control over the degree of the FOV expansion or compression.

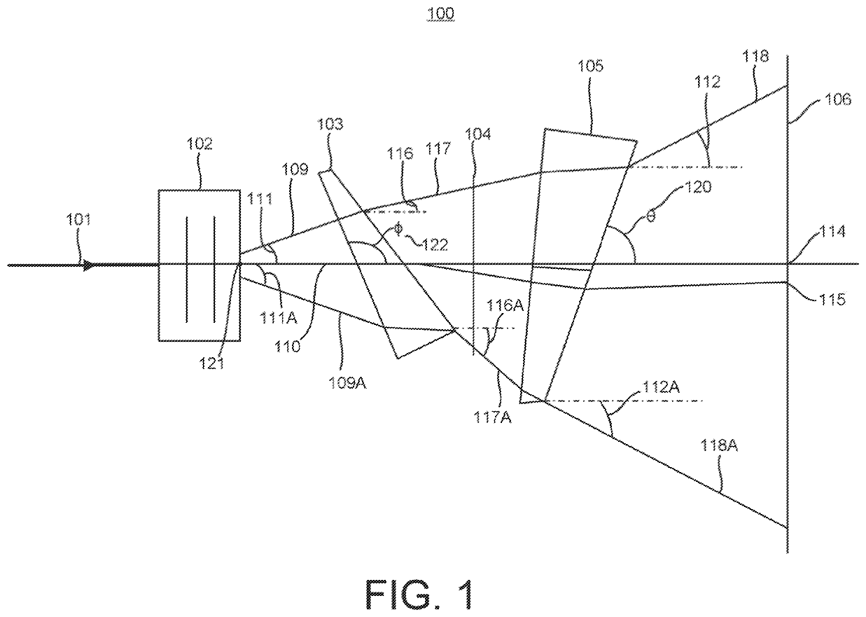

FIG. 1 depicts an optical apparatus 100, in accordance with some example embodiments. The apparatus includes a beam scanner 102, a first prism 103, and second prism 105. The optical apparatus 100 is configured to cause FOV expansion.

An incident beam 101 is provided to beam scanner 102, which redirects or scans the beam in multiple directions over time.

In some examples, two or more incident beams with a same incident angle or different incident angles are provided to the beam scanner 102 at the same time or at different times. In some examples, the two or more incident beams may come from two or more diode dies packaged together. In some examples, the two or more diode dies are packaged on a substrate which is electrically connected to a same printed circuit board. In some examples, the two or more incident beams may come from two or more laser diodes. In some examples, the two or more laser diodes are electrically connected to a same printed circuit board.

Scanner 102 directs the beam in one direction at one time and another direction at another time thereby producing a scan pattern over time. In a dimension, the beam is deflected to maximum deflection angle 111 between an optical axis 110 and the scanned beam 109. Scanned beam 109 passes through first prism 103 toward the apex end of the prism, is refracted, and exits first prism 103 at an angle 116 to the optical axis as first refracted beam 117. When the beam is scanned in the opposite direction, the beam is scanned to a maximum deflection angle 111A, the beam 109A passes through first prism 103 toward the base end of the prism, is refracted, and exits first prism 103 at an angle 116A to the optical axis as first refracted beam 117A. The beams 117 and 117A (and all beams in between) may pass through intermediate surface 104. Beam 117 then passes through second prism 105, is refracted, and exits second prism 105 at angle 112 to the optical axis as second refracted beam 118. Beam 117A passes through second prism 105, is refracted, and exits second prism 105 at angle 112A to the optical axis as second refracted beam 118A. The beams 118 and 118A may pass through intermediate surface 106. For example, a comparison of the sum of the angles 116 and 116A with the sum of the angles 111 and 111A can reveal whether expansion or compression occurs. Note that surfaces 104 and 106 are not physical surfaces, and are virtual surfaces for the purpose of explanation of the disclosed system.

In the example of FIG. 1, first prism 103 and second prism 105 are positioned to cause an expansion of the FOV. By expansion, the FOV determined by angle 112 and/or 112A is greater than the FOV determined by angle 111 and/or 111A. For example, the FOV is expanded when angle 112 is greater than angle 111 and angle 112A is greater than 111A, or when angle 112 is greater than angle 111 and/or angle 112A is greater than angle 111A. To cause expansion, first prism 103 is positioned at an angle, ϕ, between a first face of first prism 103 and the optical axis that is greater than 90 degrees where the apex is closer to location 121 than the base of the first prism 103. The second prism 105 is positioned at an angle, ϕ, between a second face of second prism 105 and the optical axis that is less than 90 degrees where the apex is closer to location 121 than the base of the second prism 105. The first and second prisms may cause a shift in the optical axis from a position 114 to position 115 at, for example, surface 106.

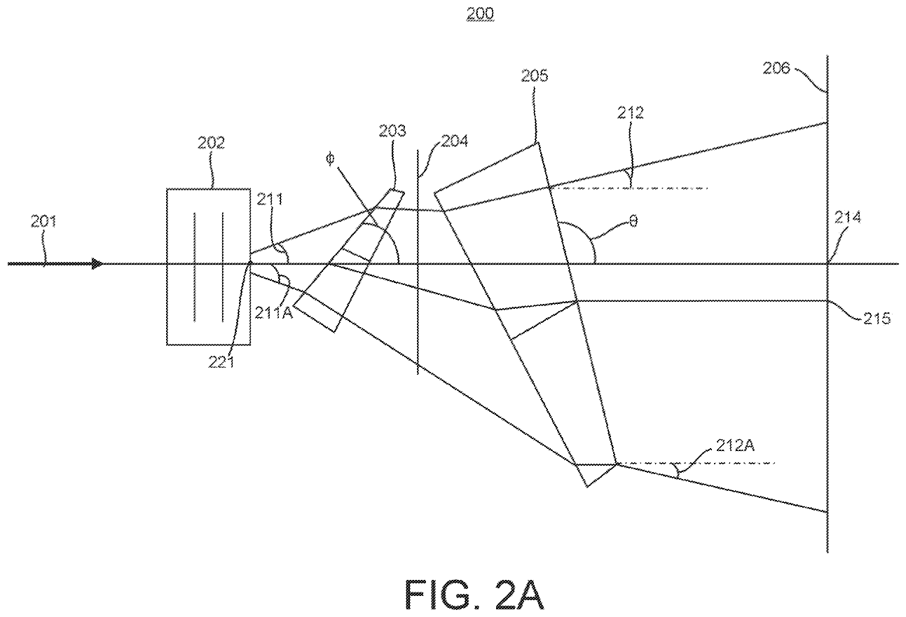

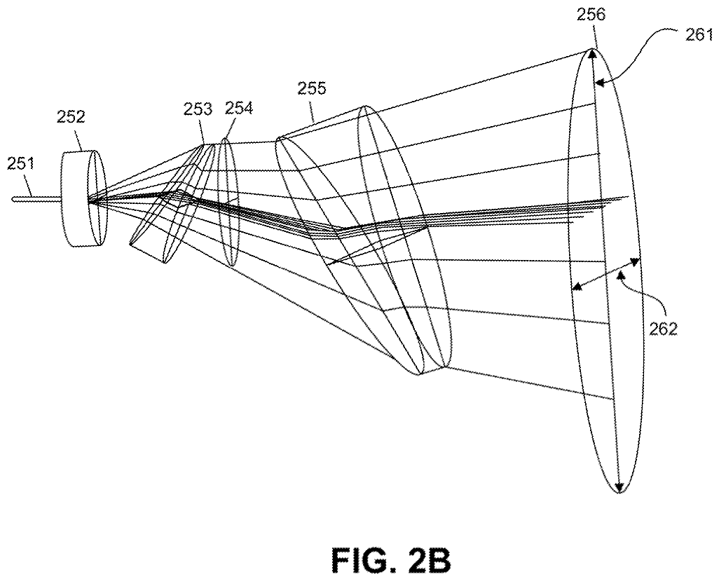

FIG. 2A depicts an optical apparatus 200, in accordance with some example embodiments. The apparatus includes a beam scanner 202, a first prism 203, and second prism 205. The optical apparatus 200 is configured to cause FOV compression.

In the example of FIG. 2A, first prism 203 and second prism 205 are positioned to cause a compression of the FOV. By compression, the FOV determined by angle 212 and/or 212A is less than the FOV determined by angle 211 and/or 211A. For example, the FOV is compressed when the sum of angle 212 added to 212A is less than the sum of angle 211 added to 211A. To cause compression, first prism 203 is positioned at an angle, ϕ, between a first face of first prism 203 and the optical axis that is less than 90 degrees where the base is closer to location 221 than the apex of the first prism 203. The second prism 105 is positioned at an angle, ϕ, between a second face of second prism 205 and the optical axis that is greater than 90 degrees where the base is closer to location 221 than the apex of the second prism 205. The first and second prisms may cause a shift in the optical axis from a position 214 to position 215 at, for example, surface 206.

FIG. 2B depicts an example of an optical apparatus including optical scanner 252, first prism 253, and second prism 255, depicting 3-dimensional views of the at least some of the optical components and the optical rays. Planes that are shown at 254 and 256 are not physical objects, but are included to assist the reader with determining the boundaries of optical rays at an intermediate plane 254 and at the image plane 256. As such, 254 and 256 may be referred to as virtual faces. The FOV is compressed in the vertical direction shown at 261. There is no compression or expansion in the horizontal direction shown at 262.

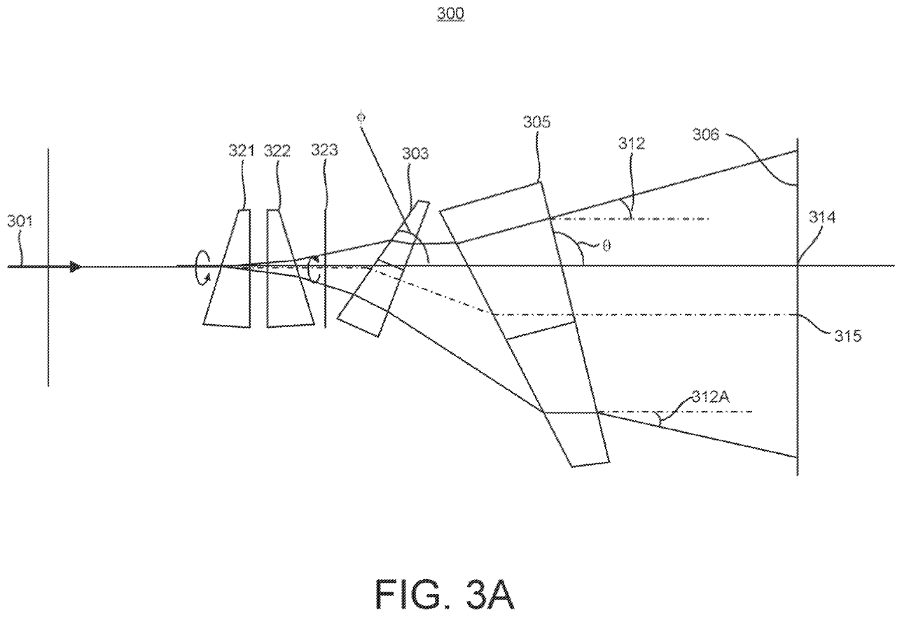

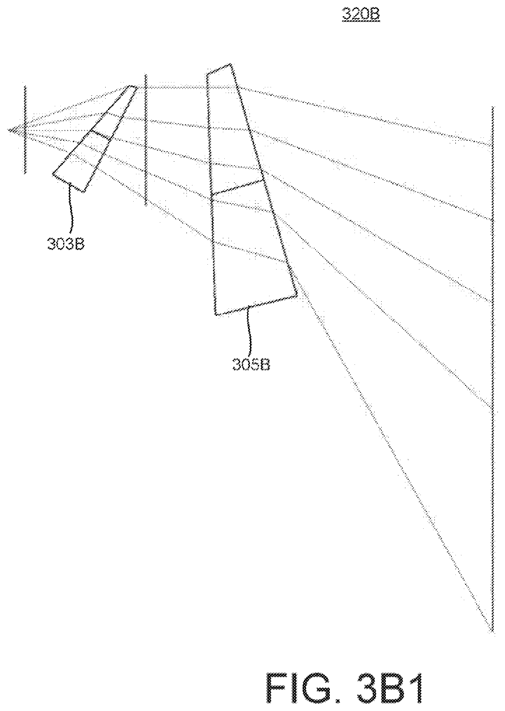

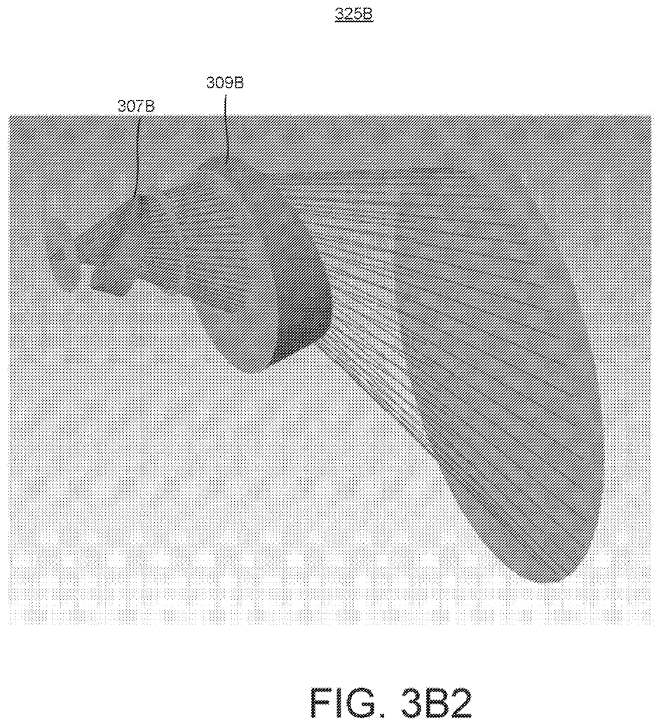

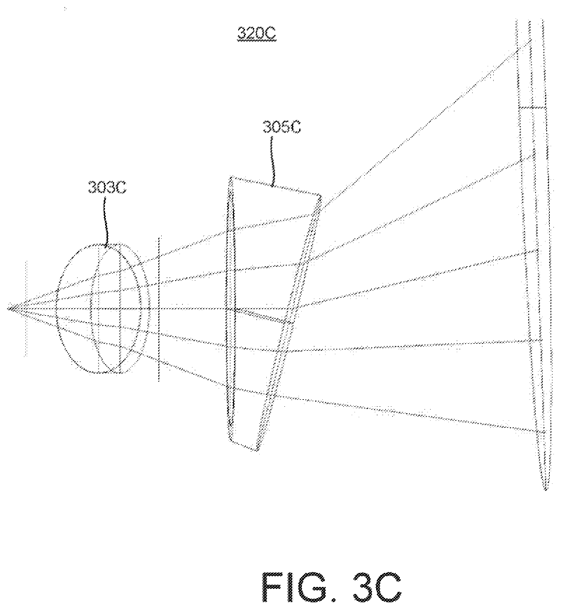

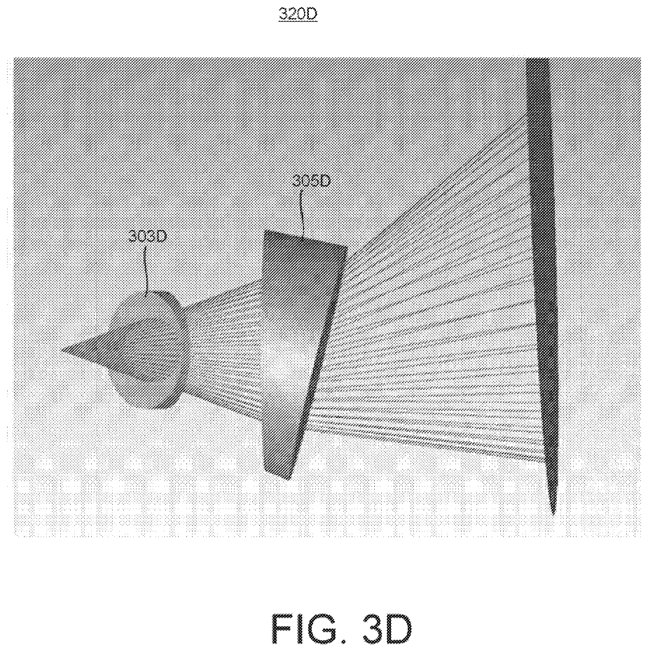

FIG. 3A depicts an optical apparatus 300, in accordance with some example embodiments. The apparatus in FIG. 3A is configured to cause FOV compression similar to FIG. 2A, and further illustrates some of the components in the beam scanner section. The apparatus 300 includes a first prism 303 and second prism 305 positioned to cause FOV compression. Compared to FIG. 2, FIG. 3A illustrates one implementation of beam scanner 202 which includes third prism 321 and fourth prism 322. Prisms 321 and 322 are rotatable in counter-rotating directions. For example, prism 321 may be spun (by a motor, for example) in a clockwise direction while prism 322 is spun in a counterclockwise direction. In some example embodiments, one prism may be spun at a rate of about 10,300 revolutions per minute (RPM) and the other prism may be spun at 2800 RPM. Other rotational speeds can also be used. Each of the four prisms are constructed of an optically transparent material which, in some embodiments, has a refractive index of about 1.509. One or more of the prisms 321 and 322 may have an apex angle of 18 degrees. In some example embodiments, the third prism 321 and fourth prism 322 may scan a beam over a full angle equal to the sum of angle 312 and 312A equal to 40 degrees.

FIG. 3B1 depicts a ray tracing diagram of two prisms 303B and 205B to change an FOV. At 320B is a ray tracing diagram, illustrating some of the rays that travel through the system.

FIG. 3B2 depicts at 325B a three-dimensional illustration of the prisms 307B and 309B and their orientation with respect to one another, as well as the bundle of rays that traverse the system.

FIGS. 3B1 and 3B2 are examples with wedge angles that are the same, with the same tilt directions. In FIGS. 3B1 and 3B2, the beam is incident from the thick side of the first prism, compressed by the first prism in the vertical direction, and then incident to the thin side of the second prism, which expands in the vertical direction.

The prisms in FIG. 3B1-B2 are oriented differently than in FIGS. 1, 2A, and 3A. In FIG. 3B, a first prism is oriented (tilted) with the base closer to the source than its apex. A second prism is oriented with its apex closer to the first prism than its base. The first prism in FIG. 3B1-B2 compresses the FOV in a first direction, and the second prism expands the FOV in a second direction. The first direction and the second direction can be the same direction, or 90 degrees (or another angle) different from one another. In some embodiments, the first prism may expand the FOV instead of compressing, and the second prism may compress the FOV instead of expanding.

In contrast, FIG. 1 shows the apex of the first prism closer to the source than the base, the second prism is flipped over compared to the first with the apex of the second prism closer to the first prism than the base of the second prism. FIG. 2 shows the base of the first prism closer to the source than the apex, and the base of the second prism closer to the first prism than the base. The prisms in FIGS. 2B and 3A are similarly oriented to FIG. 2A.

FIG. 3C is another configuration that includes two prisms 303C and 305C used to change an FOV. At 320C is a ray tracing diagram illustrating some of the rays that travel through the system. FIG. 3D illustrates a three-dimensional view 320D of the prisms and their orientations with respect to one another. In some embodiments, the first prism may expand the FOV in a first direction and the second prism may compress the FOV in a second direction. In other embodiments, the first prism may compress the FOV in a first direction and the second prism may expand the FOV in a second direction. In some embodiments, the first direction is perpendicular to the second direction and in other embodiments it is not.

The second prism in the foregoing embodiments (105/205/255/305/305B/309B/305C/305D) can be used to achieve multiple affects including causing an offset to the center of the FOV compared to the optical axis (e.g., to compensate for part of the offset that was introduced by the first prism), reducing reflections using an anti-reflective coating on the second surface of the second prism that allows light to exit the second prism without substantial loss but prevent stray light or reflections to enter the second prism through the second surface, and further adjusting the FOV after any adjustment (e.g., expanding or compressing) to the FOV performed by the first prism.

The disclosed embodiments may include one or more of the following features. The degree of change in FOV caused by the first prism is close to the degree of change of change caused by the second prism. The deflection direction caused by the first prism is opposite to the direction of deflection caused by the second prism (in order to achieve a predetermined eccentricity). The difference between a first set of deflection angles caused by the first prism and a second set of deflection angles caused by the second prism is less than 10% of the FOV of view. The wedge angle of the first prism is opposite to the wedge angle of the second prism. The incident angles of the first and second prisms differ by less than 10 degrees (to avoid the beam deflection angles on both sides of the optical axis being too different, causing the scanning pattern no not be centrally symmetric). The angle of inclination of the light at the exit surface is less than 12 degrees (to avoid the receiving aperture being too small). The light incident on the last (e.g., second prism) is incident from the thick end to the thin end of the prism. The angle of the incident light on the last (e.g., second) prism is confined to a limited range of angles.

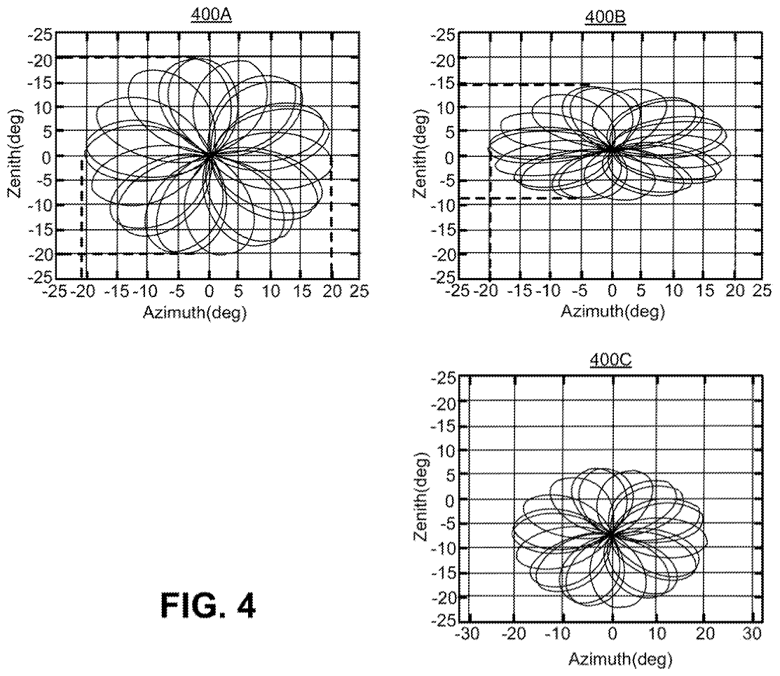

FIG. 4 depicts examples of scanning plots 400A, 400B and 400C. These scanning plots show the position of the beam over a period of time out of an optical apparatus such as the optical apparatuses described above. The plots show the location of the beam over time as a function of azimuth angle and zenith (elevation) angle. Example scan plot 400A corresponds to a scanning pattern that is generated by the scanner section without the use of additional optical components that modify the FOV. In particular, plot 400A shows a maximum scan angle in azimuth of about +/−20 degrees, and a maximum scan angle in elevation of about +/−20 degrees (above and below the horizon). The center of the scan pattern is at about 0 degrees in elevation and 0 degrees in azimuth.

Example scan plot 400B is generated when FOV expansion/compression optical elements are utilized, showing a maximum scan angle in azimuth of about +/−20 degrees, and a maximum scan angle in elevation of about +15 degrees to −8 degrees. The center of the scan pattern is at about 0 degrees in azimuth and +2 degrees in azimuth. In an embodiment producing the example scan plot 400B, prisms 303 and 305 are made of a material with refractive index 1.82. Prism 303 has an apex angle of 14 degrees and is tilted at 30 degrees. Prism 305 has an apex angle of 20 degrees and is tilted at 8 degrees. In this example, the elevation angle is compressed from 40 degrees to 22 degrees which is a compression ratio of 0.55.

In FIG. 4, example scan plot 400C is generated when FOV expansion/compression optical elements are utilized, showing a maximum scan angle in azimuth of about +/−20 degrees, and a maximum scan angle in elevation of about +5 degrees to −22 degrees. The center of the scan pattern has also been shifter compared to the center in plots 400A and 400B, and is at about 0 degrees in azimuth and −7 degrees in azimuth.

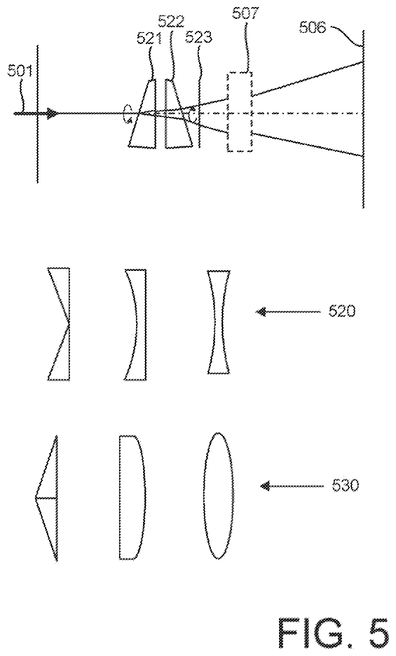

FIG. 5 depicts an optical scanning apparatus similar to the optical scanning apparatus in FIG. 3. FIG. 5 includes prism 521 that is similar to prism 321 and prism 522 that is similar to prism 322. Prisms 521 and 522 may counter-rotate similar to prisms 321 and 322. Optical element 507 is used for FOV compression or expansion. The apparatuses of FIGS. 1-3 include prisms to cause expansion or compression. In FIG. 5, other optical elements may be additionally or alternatively used to cause expansion or compression. For example, optical elements 520 including concave lenses, plano-concave lenses, or mirrors may be used to cause FOV expansion. Example of optical elements 530 that can be used to cause FOV compression include convex lenses, plano-convex lenses, or mirrors.

To further illustrate the principle of operation of the disclosed technology, FIGS. 6A-6H2 are provided below that show either a single prism element or multiple prisms, in addition to simplified ray trace diagrams. FIG. 6A depicts a prism 602 made from a material with refractive index, n 608, and having apex 604 and base 606. The angle at apex 604 is denoted by a 603. An input beam strikes the prism at an angle θ₁ 610 to a normal to the first surface, is refracted, and exits the other side of the prism at angle θ₂ 612 formed between a normal to the second surface and the output beam. Angle δ 614 is the angle between the input beam if passed straight through the prism and direction and the output beam direction. A relationship between the angles of the prism may be expressed as:

$$δ = α ( n \frac{cos ( {θ}_{2} )}{cos ( {θ}_{1} )} - 1 ) . \qquad Equation ( 1 )$$

FIG. 6B depicts an example of a plot 600B of a deflection angle derivative, dδ/dθ₁, as a function of input angle, θ₁, where angle δ and angle θ₁ are described above, for a prism. The plot in FIG. 6B can assist in selecting the proper prism for producing expansion or compression of FOV. The derivative expresses rate of change of light beam deflection angle, δ, with respect to the incident input angle, θ₁. In region 610 of FIG. 6B between an input angle of about −90 degrees and −18 degrees, the prism reflects the input beam due to total internal reflection. At angles with less negative values (−15 degrees, for example) up to about 0 degrees, the prism expands the FOV of the output beam range of angles compared to the input beam range of angles. At angles with a positive value (+5 degrees, for example), the prism compresses the FOV of the output beam range of angles compared to the input beam range of angles. The above plot can be used for the selection of prisms such as prisms 103/203/303 and 105/205/305 described above. In the example plot of FIG. 6B, the index of refraction of the prism material, n, is 1.8, and the apex angle, α, is 25 degrees.

In one implementation, to achieve FOV expansion, an input beam is incident on a first prism at a negative angle (as described above, placing the angle of the incident beam in region 620), and a second prism with its wedge angle reversed, the beam from the first prism arriving at an angle that is negative relative to a normal to the second prism surface. The combined expansion of both prisms may be expressed as the multiplication of the expansion by each of the two prisms.

In one implementation, to achieve FOV compression, an input beam is incident on a first prism at a positive angle (as described above, placing the angle of the incident beam in region 630), and a second prism with its wedge angle reversed, the beam from the first prism arriving at an angle that is positive relative to a normal to the second prism surface. The combined expansion of both prisms may be expressed as the multiplication of the compression by each of the two prisms.

The above-described example embodiments can be realized to cause a large angle compression/expansion (e.g., 0.4 to 2.2-fold compression/expansion). A practical limit may occur when the beam is offset in position or the total deflection angle is too large. The foregoing limit may be addressed by placing the first prism at a large angle with the incident light to achieve the first large angle expansion of the light beam, and the second prism is placed at a small angle or a reverse angle with the main optical axis to achieve a second small angle expansion of the light beam or small angle compression. The combination causes a predetermined angle of expansion of the beam.

In some example embodiments, three prisms may be used to cause expansion or compression. For example, the three prisms may cause compression or expansion. In some embodiments, the first two prisms may cause expansion or compression and the third prism may adjust an eccentricity of the beam and an angle with the optical axis.

In some example embodiments, four prisms may be used for compression or expansion. For example, the four prisms may cause compression or expansion. In some embodiments the first three prisms may cause expansion or compression and the fourth prism may adjust an eccentricity of the beam and an angle with the optical axis.

In some example embodiments, four prisms include two pairs of prisms. The first pair may realize horizontal FOV expansion or compression, and the second pair may be rotated 90° on the optical axis to realize vertical FOV expansion or compression.

In other example embodiments, the first pair may realize FOV expansion or compression in a predetermined direction, and the second pair rotated a predetermined angle on the optical axis to realize FOV expansion or compression in a predetermined direction.

FIG. 6C illustrates an example of a 3D view of a prism 650C. The prism in FIG. 6C (and many of the prisms disclosed herein) may be referred to as wedge prisms. The wedge prism in FIG. 6C has faces that are circular in shape which may also be expressed as the prism having a circular cross section in a first dimension (a vertical dimension in FIG. 6C). The prism material is thicker at one side than the other with a linear taper from the thick side to the narrow side. A cross-sectional shape in a dimension perpendicular to the first dimension is rectangular as shown at 654C. It should be noted that in some embodiments, prisms having wedge cross-sections in two directions may be used. Shown at 652C is a reference direction that may be used to describe an orientation of a prism such as the prism shown in FIG. 6C.

FIG. 6D illustrates another example of a 3D view of a prism 650D. A cross-sectional view is shown at 652D that is perpendicular to the cross-sectional view 654C shown in FIG. 6C.

FIG. 6E illustrates another example of a 3D view of a prism 650E showing various dimensions and an angle. Incoming light 654E is incident on a face of the prism, is refracted, and exits the opposite face. The prism has dimensions A, B, and C, and has an apex angle of α, and top surface 652E.

FIG. 6F1 illustrates a ray diagram 650F showing a prism 652F tilted with respect to incoming rays with the apex closer to the source than the base. When the angle between the beam and the normal 654F of the incident surface is negative (that is, the beam is incident between the normal and the wedge angle), the overall FOV can be expanded by the prism. The greater the angle of incidence of the incident rays, the greater the degree of expansion up until when the incident angle is large enough that total internal reflection occurs at the second surface. FIG. 6F2 illustrates a 3D view 666F of the prism 668F in FIG. 6F1.

FIG. 6G1 illustrates a ray diagram 650G showing a prism 652G tilted with respect to incoming rays with the base closer to the source than the apex. When the angle between the beam and the normal 654G of the incident surface is positive (i.e., the incoming light ray hits the prism surface from below the surface normal), the FOV can be compressed by the prism. The greater the angle of incidence of the incident rays, the greater the degree of compression, but the greater the difference in the deflection angles of the two beams on the left and right sides of the optical axis. For example, FIG. 6H1 which has a greater angle of incidence to the incoming rays than FIG. 6G1, the deflection angles of the rays are larger. While the configuration in FIG. 6H1 may be useful in some applications, in other applications, it may produce a scanning pattern that is too distorted. FIG. 6G2 illustrates a 3D view 656G of the prism 658G in FIG. 6G1 and FIG. 6H2 illustrates a 3D view 656H of the prism 658H in FIG. 6H1.

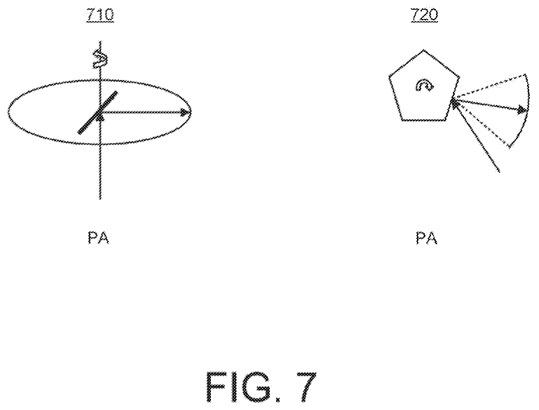

FIG. 7 depicts examples of scanners, at least some of which can be used as the scanner or a portion of the scanner in the foregoing figures. At 710 is a rotatable planar mirror that is rotated or vibrates causing a scanned output beam from an input beam. The mirror may rotate via a MEMs device, a motor, galvanometric device, or other device. At 720 is a rotatable polygonal mirror. Shown is a five-sided mirror where each side is a flat mirror similar to the planar mirror at 710. The polygonal mirror is rotated by a motor or other device causing an input beam to be scanned. Apparatuses including multiple scanning devices may be used to scan in two dimensions such as azimuth and elevation.

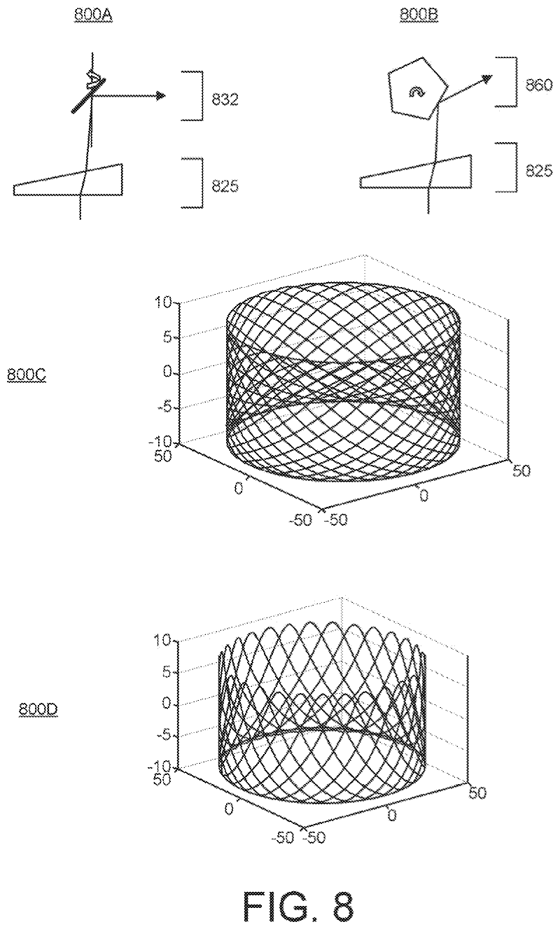

As noted earlier, in some instances it may be desirable to produce additional control and manipulation to produce optical scanning pattern that are flat at one or more sides, have rectangular boundary, or can otherwise be controlled in one or more dimensions. In this regard, FIG. 8 depicts examples of scanner configurations and scanning patterns. At 800A an optical apparatus is shown with two scanners including a rotatable single prism 825 and a rotatable flat mirror 832. At 800B an optical apparatus is shown with two scanners including a rotatable single prism 825 and a rotatable polygonal mirror 860. When the planar mirror in 832 and the prism in 825 of 800A or the rotatable single prism 825 and a rotatable polygonal mirror 860 of 800B are rotated in opposite directions, beam scanning patterns such as the patterns shown at 800C and 800D may be generated from an input beam. The example plots 800C and 800D show scanning over azimuth and elevation angles.

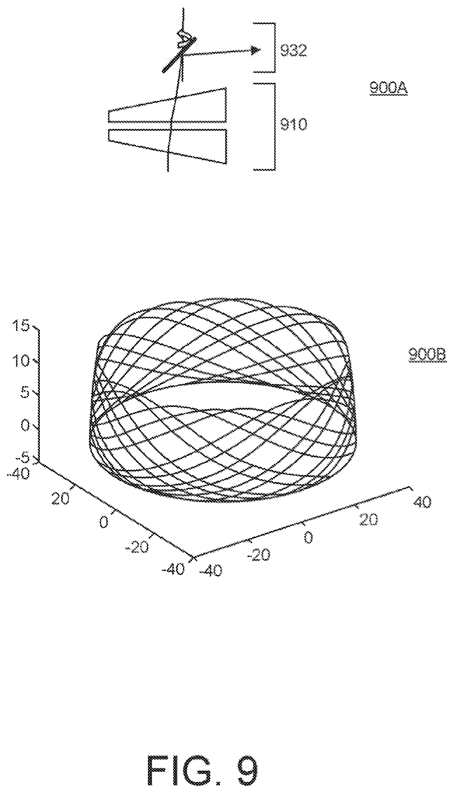

FIG. 9 depicts a further example of a scanner configuration and a scanning pattern. At 900A an optical apparatus is shown with two scanners including a rotatable pair of prisms 910 and a rotatable flat mirror 932. When the planar mirror in 932 is rotated and the pair of prisms a rotated in opposite directions a beam scanning pattern such as the pattern shown at 900B may be generated from an input beam. The example plot 900B show scanning over azimuth and elevation angles. In some example embodiments, the prisms may be rotated in the same direction with different rotation speeds.

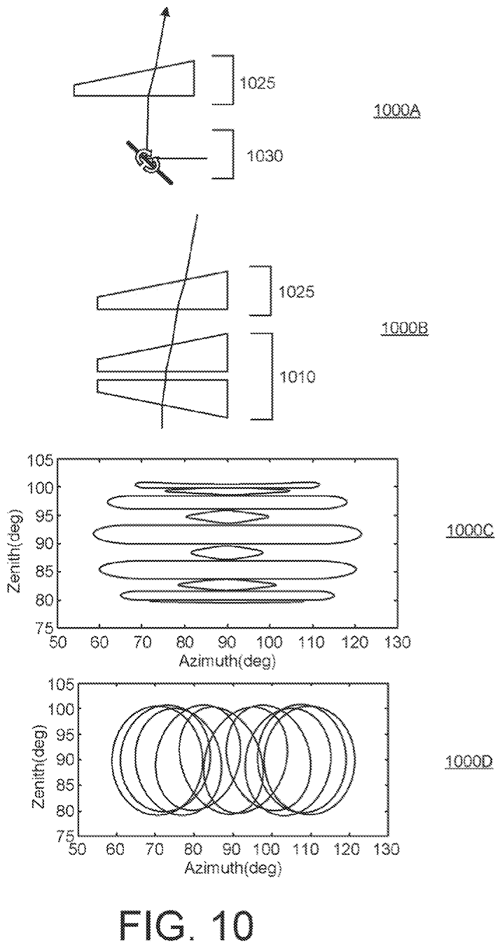

FIG. 10 depicts additional examples of scanner configurations and scanning patterns. At 1000A an optical apparatus is shown with two scanners including galvanometer 1030 and a rotatable single prism 1025. At 1000B an optical apparatus is shown with two scanners including a pair of rotatable prisms 1010 and a rotatable single prism 1025 with light first entering rotatable prisms 1010. In some example embodiments, rotatable single prism 1025 may be swapped with rotatable prisms 1010 so that light first enters with light first entering rotatable single prism 1025. When the galvanometer 1030 and the prism 1025 of 1000A are rotated in opposite directions, beam scanning patterns such as the patterns shown at 1000C and 1000D may be generated from an input beam. When the rotatable pair of rotatable prisms 1010 are counter-rotated and the rotatable single prism 1025 is rotated the beam scanning patterns such as the patterns shown at 1000C and 1000D may be generated from an input beam. The example plots 800C and 800D show scanning over azimuth and elevation (zenith) angles. The scan pattern in 1000C is a horizontal (or flat) scan pattern that is also scanned in elevation. The scan pattern in 1000D is a circular scan pattern that is also scanned horizontally. Depending on the relative speeds of the galvanometer 1030 compared to the rotatable single prism 1025, or the relative speeds of the counter-rotating prism pair 1010 compared to single prism 1025, different patterns may be generated such as 1000C and 1000D. In some example embodiments, the speed of 1010 is greater than the speed of 1025. For example, the speed of 1010 may be greater than 5 times the speed of 1025, or 8 times, or 9 times. The prisms throughout this description including at 1025 and 1010 may be different sizes from one another.

Regarding the scanner configuration at 1000B, the counter-rotating prism pair 1010 (also sometimes referred to as a Risley prism pair) may rotate at equal speeds and, when combined with a third prism 1025, may cause scanning lines that are flat or horizontal when the rotation speeds of the two equal-speed counter-rotating prisms are greater than the speed of the third prism 1025. In this way, the point clouds that are generated can be in the horizontal direction (as shown 1000C) which may have application in autonomous driving as well as many other applications.

In some example embodiments, the apex angles of the three prisms in 1000B are α₁, α₂, α₃, and the refractive indices are n₁, n₂, n₃. The rotation angles of the three prisms are θ₁, θ₂, θ₃. The angle of rotation of the prism is defined as the direction of the wedge angle of the prism with respect to x axis.

The physical parameters of the three prisms may be the same or different. For example, prism 1 may be the same as the prism 2 (geometry and refractive index). So, in this example α₁=α₂ and n₁=n₂.

When prism 1 and prism 2 are rotated and θ₁+θ₂=2nπ (n is an integer), the light is scanned in the horizontal direction after passing through prism 1 and prism 2. The extent of the scan is related to the wedge angle of the prism 1 and prism 2 and the refractive index. The FOV after the prism pair may be expressed as:

F₁=2(n₁−1)α₁ Equation (2).

After passing through the rotating prism 3, the light will rotate around the incident direction. The angle of rotation of the rotating piece is related to the wedge angle and refractive index of the prism, and the deflection angle may be expressed as:

F₃=(n₃−1)α₃ Equation (3).

After the light passes through the three prisms, the exit direction may be equivalent to the superposition of the horizontal scan and the circular scan, so a flat FOV may be formed. By controlling the refractive index and wedge angle parameters of the prism, the FOV in both directions can be flexibly adjusted.

The FOV range in the horizontal and vertical directions may be expressed as:

FOV_{H}=F₁+F₃=2(n₁−1)α₁+(n₃−1)α₃

FOV_{V}=F₃=(n₃−1)α₃ Equation (4).

In some embodiments of the disclosed subject matter, a first scanner may scan along a particular line, B1 (not shown), and the second scanner may scan along a second line, B2 (not shown), where B1 and B2 are at an angle to one another (for example, perpendicular to each other).

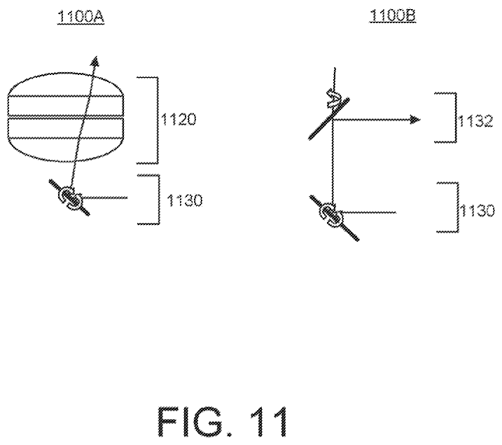

FIG. 11 depicts additional examples of scanner configurations. At 1100A an optical apparatus is shown with two scanners including a galvanometer 1130 and a pair of rotatable prisms 1120. The rotatable prisms 1120 can, for example, be a Risley prism pair. At 1100B, two galvanometers 1130 and 1132 are shown.

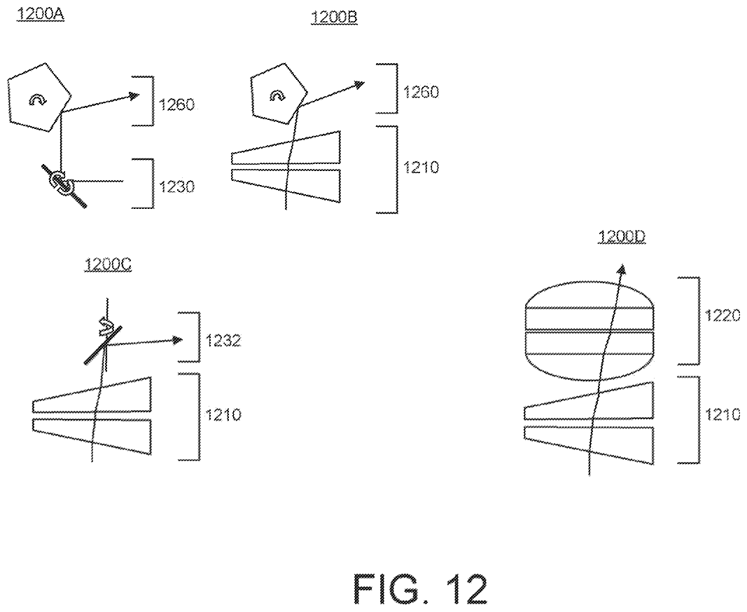

FIG. 12 depicts additional examples of scanner configurations. At 1200A, a galvanometer 1230 and a rotatable polygonal mirror are shown. At 1200B, a pair of pair of rotatable prisms 1210 which may counter-rotate and a rotatable polygonal mirror 1260 are shown. At 1200C a pair of rotatable prisms 1210 which may counter-rotate (e.g., a Risley pair), and a galvanometer 1232 are shown. At 1200D two pairs of rotatable prisms, each pair which may counter-rotate, are shown.

When the speeds of the two counter-rotating prisms are −w and +w, the scanned pattern can approximate a straight line. When the rotating mirror has a rotation speed, a, and the two counter-rotating prisms rotate at a−w and a+w, two mutually perpendicular straight lines can be scanned to form a rectangular scanning area.

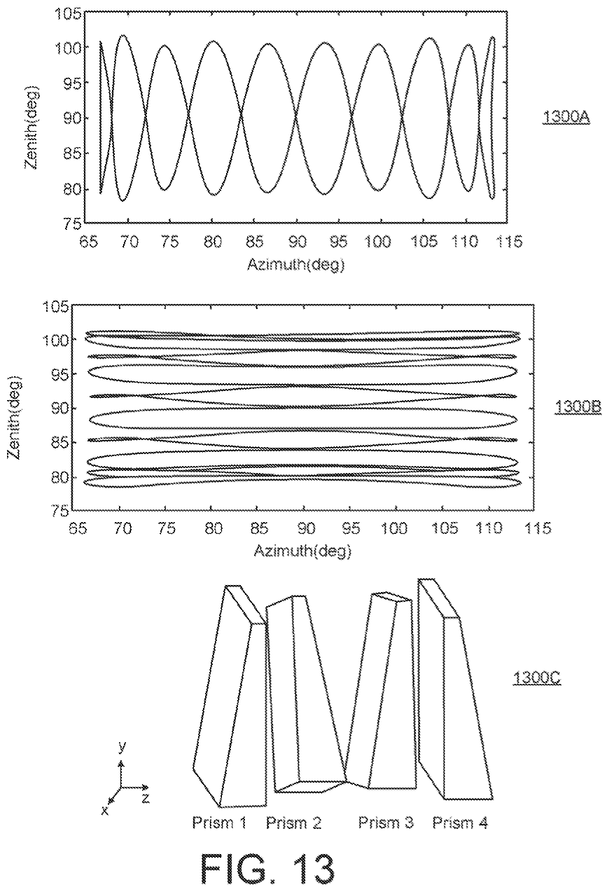

FIG. 13 at 1300A and 1300B depicts scan patterns of the above scanning devices at different relative speeds.

FIG. 13 at 1300C depicts four prisms tilted with respect to one another. The wedge angles of the four prisms are α₁ to α₄, the refractive indices are respectively n₁ to n₄, and the rotation angles of the four prisms are θ₁ to θ₄. The rotation angle of the prism may be defined as the prism wedge angle direction.

The parameters of the four prisms can be the same or different. For example, prism 1 may be in the same pair as prism 2 (geometry and material refractive index), and prism 3 may be in the same pair as prism 4 (geometry and material refractive index).

In this example, a₁=α₂, α₃=α₄, n₁=n₂, and n₃=n₄. When prism 1 and prism 2 are rotated and θ₁+θ₂=2nπ (n is an integer), the light may be scanned in the horizontal direction after passing through prism 1 and prism 2. The range of scanning (i.e., horizontal FOV) is related to the wedge angle of prism 1 and prism 2, which may be expressed as:

FOV_{H}=4(n₁−1)α₁ Equation (5).

When prism 3 and prism 4 rotate and satisfy θ₁+θ₂=(2n+1)π (n is an integer), the light passes through prism 3 and prism 4 and is scanned in the vertical direction and the FOV may be expressed as:

FOV_{V}=4(n₃−1)α₃ Equation (6).

By designing the wedge angle and refractive index of the prism, it is possible to flexibly design the horizontal and vertical FOV. The following provides a list of example features that can be included.

1. FOV azimuth and elevation angles can be controlled separately.

2. Expansion and compression may be adjusted over a range (e.g., 0.4-2.2 times).

3. Supports coaxial transmission/reception with the same FOV;

4. FOV can be adjusted by stationary prisms that can be varied to change the FOV thereby reducing the complexity of the control system;

5. By adding correctly positioned prism(s) a certain scanning range of the FOV can be achieved.

6. Two counter-rotating wedge prisms can be used to scan in a straight line.

7. By using a single-sided mirror that rotates about a shaft, scan coverage of up to 360° can be achieved;

8. Two sets of counter-rotating mirrors can achieve a rectangular scan pattern.

9. Light sources can include quasi-continuous wave (QCW), continuous wave (CW), single wavelength, and/or wavelength tunable lasers, as well as others. The light sources may produce light at one or more wavelengths including 905 nanometers, 1550 nanometers, as well as other wavelengths.

10. Dual counter-rotating prisms may scan in a flat or a straight line;

11. A single prism in combination with galvanometer planar mirror can produce a flat scanning pattern;

12. A vibrating mirror and a rotating mirror can be used to scan over 360° in azimuth and a predetermined range of elevation.

13. A double prism and a reflector assembly, where the rotational speed of the mirror is a, and the rotation speed of the prism is a+w and a−w, can be used to achieve scanning over 360°.

14. A galvanometer planar mirror combined with a polygonal mirror can cause a scan range within a predetermined angle range.

15. A double prism rotated at constant velocity combined with a polygonal mirror can cause a scan range within a predetermined angle range.

16. Four prisms rotated at two different velocity with rotation angles: (2n+1)π or (2n+½)π may scan in a rectangular pattern, which can lead to independent scanning in azimuth and elevation directions.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, and systems.

1.-19. (canceled)

20. An optical expansion or compression device, comprising:
at least two optical elements including:
a first optical element to receive an optical beam having a first scanning pattern and produce a first redirected beam; and
a second optical element to receive the first redirected beam and produce a second redirected beam, wherein the second redirected beam has a second scanning pattern,
wherein each of the first and the second optical elements are configured to be positioned with respect to each other at a range of angles such that when the first optical element is positioned with respect to the second optical element in a first predetermined range of angles, the second scanning pattern is produced with an expanded a field of view, and when the first optical element is positioned with respect to the second optical element in a second predetermined range of angles, the second scanning pattern is produced with a compressed field of view.

21. An optical scanning device, comprising:
a first beam scanner section configured to receive an input light beam and to produce a first scanning pattern including a circular or an oval scanning beam section; and
a second beam scanner section positioned to receive light from the first beam scanner section and to produce an output beam having a second scanning pattern, wherein the second scanning pattern includes at least one flat or straight boundary.

22. The optical scanning device of claim 21, wherein the first beam scanner section includes a pair of prisms rotatable in counterrotating directions.

23. The optical scanning device of claim 21, wherein the second beam scanner section includes a pair of prisms rotatable in counterrotating directions.

24. The optical scanning device of claim 21, wherein the first or second beam scanner section includes a single rotatable prism.

25. The optical scanning device of claim 21, wherein one or more of the first or second beam scanner section includes a steerable mirror.

26. The optical scanning device of claim 21, wherein the first or second beam scanner section includes a rotatable polygonal mirror.

27. The optical scanning device of claim 21, wherein the second pattern is a line in elevation that is scanned in azimuth.

28. The optical scanning device of claim 21, wherein the second pattern is a line in azimuth that is scanned in elevation.

29. The optical scanning device of claim 21, wherein the second pattern is a circle that is scanned in azimuth.

30. An optical scanning device, comprising:
a first beam scanner section including a first prism and a second prism, the first and the second prisms configured to rotate in opposite directions with respect to each other, the first prism having a first rotation speed and the second prism having a second rotation speed; and
a second beam scanner section positioned to receive light from the first beam scanner section, the second beam scanning section including a third and a fourth prism, wherein the third and the fourth prisms are configured to rotate in opposite directions with respect to each other, the third prism having a third rotation speed and the fourth prism having a fourth rotation speed, wherein the first, the second, the third and the fourth rotation speeds are selectable to produce an output beam having a particular scanning pattern.

31. The optical scanning device of claim 30, wherein each of the first, second, third and fourth prisms has a corresponding first, second, third and fourth apex or wedge angle and a corresponding first, second, third and fourth index of refraction, and wherein one or more of a proregression, a shape or a boundary of the particular scanning pattern of the output beam is determined in accordance with the first through the fourth rotation speeds and the first through the fourth indices of refraction.

32. The optical scanning device of claim 30, wherein the first and the second beam scanner sections enable control of an extent of a field of view for the output beam.

33. The optical scanning device of claim 30, wherein the control of the extent of the field of view for the output beam includes control of the field of view in a vertical and in a horizontal direction.

34. The optical scanning device of claim 30, wherein the particular scanning pattern of the output beam includes at least one flat boundary section.

35. The optical scanning device of claim 30, wherein the particular scanning pattern of the output beam is a rectangular scan pattern.

36. The optical scanning device of claim 21, wherein the first beam scanner section includes a rotatable single prism, and the second beam scanner section includes a rotatable flat mirror.

37. The optical scanning device of claim 36, wherein the rotatable single prism of the first beam scanner section and the rotatable flat mirror of the second beam scanner section are rotatable in opposite directions.

38. The optical scanning device of claim 21, wherein the first beam scanner section includes a rotatable single prism, and the second beam scanner section includes a rotatable polygonal mirror.

39. The optical scanning device of claim 38, wherein the rotatable single prism of the first beam scanner section and the rotatable polygonal mirror of the second beam scanner section are rotatable in opposite directions.
